(19) United States
(12) Patent Application Publication
(10) Pub. No.: US 2022/0217355 A1
(43) Pub. Date: Jul. 7, 2022

(54) METHOD AND APPARATUS FOR ENCODING AND DECODING A VIDEO BITSTREAM FOR MERGING REGIONS OF INTEREST

(71) Applicant: CANON KABUSHIKI KAISHA, Tokyo (JP)

(72) Inventors: Naël OUEDRAOGO, VAL D'ANAST (FR); Eric NASSOR, THORIGNE-FOUILLARD (FR); Gérald KERGOURLAY, CHEVAIGNE (FR); Franck DENOUAL, SAINT DOMINEUC (FR)

(21) Appl. No.: 17/612,984

(22) PCT Filed: May 26, 2020
(86) PCT No.: PCT/EP2020/064533

§ 371 Date: Nov. 19, 2021

(30) Foreign Application Priority Data
May 28, 2019 (GB) 1907514.2

(51) Int. Cl. H04N 19/134; H04N 19/40; H04N 19/46; H04N 19/70; H04N 19/176

(52) U.S. Cl. CPC H04N 19/134; H04N 19/40; H04N 19/176; H04N 19/70; H04N 19/46

(57) ABSTRACT

A method of encoding video data comprising pictures into a bitstream of logical units, pictures being divided into picture portions, picture portions being grouped into picture portion groups, the method comprising: identifying a picture portion group encoded as a picture portion group header and a picture portion group encoded video data, the picture portion group header comprising at least one identifier of a logical unit containing a parameter set; generating rewriting information comprising a new value of the identifier of the logical unit containing the parameter set; and encoding the video data into a bitstream comprising the picture portion group and the rewriting information.

### FIELD OF THE INVENTION

The present disclosure concerns a method and a device for encoding and decoding a video bitstream that facilitates the merge of regions of interest. It concerns more particularly the encoding and decoding of a video bitstream resulting of the merging of regions coming from different video bitstreams. In addition, it is proposed a corresponding method of generating such bitstream resulting from the merge of different regions coming from different video bitstreams.

### BACKGROUND OF INVENTION

An encoded video stream may be composed of different regions of interest. In order to be able to extract and decode a region of interest independently of the rest of the bitstream, encoded video are subjected to different partitionings. The main partitioning is usually a partitioning of the video into tiles that may be further divided in bricks. The regions of interest may be constituted by one or several tiles or one or several bricks grouped in entities called slices.

In some applications, it is desirable to merge some regions of interest extracted from different bitstreams to constitute a new encoded video bitstream. While each region of interest is an independent entity that can be independently decoded, when merged into a single bitstream, there may be some compatibility issues. In particular, some video data refer to parameter sets into the bitstream using some identifiers of these parameter sets. The identifiers used in each region of interest issued from different bitstreams may be identical and this situation leads to confusion in the resulting bitstream.

These identifier collisions must be detected during the merge process and fixed. Usually, this is done by changing some identifiers determined to create collision. This change of some identifier values results in the need to decode the video data, change the identifier values and re-encode the video data. This is a complex and costly process, where the merging could only consist in mixing the video data of the different region of interest if these collisions could be avoided.

### SUMMARY OF INVENTION

The present invention has been devised to address one or more of the foregoing concerns. It concerns an encoding and decoding method for a bitstream that allows solving identifier collisions when merging slices from different bitstreams by encoding rewriting directives to amend the slice encoded data. During the merging process these rewriting directives are inserted into the bitstream while the slice headers are kept unchanged. At decoding, the decoder can use the rewriting directives to amend the slice headers on the fly. Accordingly, the collisions are avoided without amending the VCL NAL units during the merging process.

According to a first aspect of the invention, there is provided a method of encoding video data comprising pictures into a bitstream of logical units, pictures being divided into picture portions, picture portions being grouped into picture portion groups, the method comprising:
identifying a picture portion group encoded as a picture portion group header and a picture portion group encoded video data, the picture portion group header comprising at least one identifier of a logical unit containing a parameter set;
generating rewriting information comprising a new value of the identifier of the logical unit containing the parameter set;
encoding the video data into a bitstream comprising the picture portion group and the rewriting information.

In an embodiment, the rewriting information further comprises a picture portion group identifier of the picture portion group.

In an embodiment, rewriting information further comprises an initial value of the identifier of the logical unit containing the parameter set.

In an embodiment, rewriting information comprises a data block of values of a set of identifiers of logical units containing parameter sets, the data block corresponding to at least part of a similar data block in the picture portion group header.

In an embodiment:
rewriting information further comprises an identifier of a second parameter set logical unit that contains an information allowing to determine whether the logical unit containing the parameter set is used for the picture portion group; and
a new value of an identifier of a logical unit containing a parameter set is present in the rewriting information only if the logical unit containing the parameter set is used for the picture portion group.

In an embodiment, the method further comprises:
generating a second rewriting information comprising the new value of the identifier of the logical unit containing the parameter set; and
inserting the second rewriting information into the bitstream to indicate that the next logical unit containing the parameter set with the initial value of the identifier in the bitstream has to be rewritten.

In an embodiment, the second rewriting information comprises a set of new values of identifiers of logical units containing parameter sets.

In an embodiment, the second rewriting information and the rewriting information are comprised in a single logical unit.

In an embodiment, the method comprises:
determining a set of picture portions as a set of motion constrained picture portions; and
associating the rewriting information with the set of motion constrained picture portions.

In an embodiment:
pictures are further divided into sub-pictures, sub-pictures being divided into picture portions; and
rewriting information further comprises a sub-picture identifier.

In an embodiment, the rewriting information is included into a supplemental enhancement information logical unit.

In an embodiment, the supplemental enhancement information logical unit is inserted into the bitstream prior to any logical unit containing encoded video data.

In an embodiment, the rewriting information is included into a dedicated logical unit.

In an embodiment, the rewriting information is included into a parameter set logical unit.

In an embodiment, the rewriting information is included into an adaptation parameter set, APS, logical unit.

In an embodiment, the logical unit containing a parameter set is an adaptation parameter set, APS, logical unit.

In an embodiment, the logical unit containing a parameter set is an picture parameter set, PPS, logical unit.

According to another aspect of the invention, there is provided a method for decoding a bitstream of logical units of video data comprising pictures, pictures being divided into picture portions, picture portions being grouped into picture portion groups, the method comprising:
parsing rewriting information comprising a new value of an identifier of a logical unit containing a parameter set;
identifying a picture portion group encoded as a picture portion group header and a picture portion group encoded video data, the picture portion group header comprising at least one identifier of the logical unit containing the parameter set;
rewriting the picture portion group header by replacing the identifier of the logical unit containing the parameter set by the new value comprised in the rewriting information; and
decoding the bitstream with the rewritten picture portion group header.

In an embodiment, the rewriting information further comprises a picture portion group identifier of the picture portion group.

In an embodiment, rewriting information further comprises an initial value of the identifier of the logical unit containing the parameter set.

In an embodiment, rewriting information comprises a data block of values of a set of identifiers of logical units containing parameter sets, the data block corresponding to at least part of a similar data block in the picture portion group header.

In an embodiment:
rewriting information further comprises an identifier of a second parameter set logical unit that contains an information allowing to determine whether the logical unit containing the parameter set is used for the picture portion group; and
a new value of an identifier of a logical unit containing a parameter set is present in the rewriting information only if the logical unit containing the parameter set is used for the picture portion group.

In an embodiment, the method further comprises:
generating a second rewriting information comprising the new value of the identifier of the logical unit containing the parameter set; and
inserting the second rewriting information into the bitstream to indicate that the next logical unit containing the parameter set with the initial value of the identifier in the bitstream has to be rewritten.

In an embodiment, the second rewriting information comprises a set of new values of identifiers of logical units containing parameter sets.

In an embodiment, the second rewriting information and the rewriting information are comprised in a single logical unit.

In an embodiment, the method comprises:
determining a set of picture portions as a set of motion constrained picture portions; and
associating the rewriting information with the set of motion constrained picture portions.

In an embodiment:
pictures are further divided into sub-pictures, sub-pictures being divided into picture portions; and
rewriting information further comprises a sub-picture identifier.

In an embodiment, the rewriting information is included into a supplemental enhancement information logical unit.

In an embodiment, the supplemental enhancement information logical unit is inserted into the bitstream prior to any logical unit containing encoded video data.

In an embodiment, the rewriting information is included into a dedicated logical unit.

In an embodiment, the rewriting information is included into a parameter set logical unit.

In an embodiment, the rewriting information is included into an adaptation parameter set, APS, logical unit.

In an embodiment, the logical unit containing a parameter set is an adaptation parameter set, APS, logical unit.

In an embodiment, the logical unit containing a parameter set is an picture parameter set, PPS, logical unit.

According to another aspect of the invention, there is provided a method for merging picture portion groups from a plurality of original bitstreams of video data into a resulting bitstream, bitstreams being composed of logical units comprising pictures, pictures being divided into picture portions, picture portions being grouped into picture portion groups, the method comprising:
parsing logical units comprising a picture portion group to determine an identifier of a logical unit containing a parameter set associated with the picture portion group;
determining that the identifier of the logical unit containing the parameter set associated with the picture portion group is conflicting with another identifier of another logical unit containing another parameter set in another picture portion group;
generating rewriting information comprising a new value of the identifier of the logical unit containing the parameter set;
generating the resulting bitstream comprising the logical units comprising the picture portion group, the rewriting information and the encoded logical units comprising the parameter sets.

In an embodiment, the rewriting information further comprises a picture portion group identifier of the picture portion group.

In an embodiment, rewriting information further comprises an initial value of the identifier of the logical unit containing the parameter set.

In an embodiment, rewriting information comprises a data block of values of a set of identifiers of logical units containing parameter sets, the data block corresponding to at least part of a similar data block in the picture portion group header.

In an embodiment:
rewriting information further comprises an identifier of a second parameter set logical unit that contains an information allowing to determine whether the logical unit containing the parameter set is used for the picture portion group; and
a new value of an identifier of a logical unit containing a parameter set is present in the rewriting information only if the logical unit containing the parameter set is used for the picture portion group.

In an embodiment, the method further comprises:
generating a second rewriting information comprising the new value of the identifier of the logical unit containing the parameter set; and
inserting the second rewriting information into the bitstream to indicate that the next logical unit containing the parameter set with the initial value of the identifier in the bitstream has to be rewritten.

In an embodiment, the second rewriting information comprises a set of new values of identifiers of logical units containing parameter sets.

In an embodiment, the second rewriting information and the rewriting information are comprised in a single logical unit.

In an embodiment, the method comprises:
determining a set of picture portions as a set of motion constrained picture portions; and
associating the rewriting information with the set of motion constrained picture portions.

In an embodiment:
pictures are further divided into sub-pictures, sub-pictures being divided into picture portions; and
rewriting information further comprises a sub-picture identifier.

In an embodiment, the rewriting information is included into a supplemental enhancement information logical unit.

In an embodiment, the supplemental enhancement information logical unit is inserted into the bitstream prior to any logical unit containing encoded video data.

In an embodiment, the rewriting information is included into a dedicated logical unit.

In an embodiment, the rewriting information is included into a parameter set logical unit.

In an embodiment, the rewriting information is included into an adaptation parameter set, APS, logical unit.

In an embodiment, the logical unit containing a parameter set is an adaptation parameter set, APS, logical unit.

In an embodiment, the logical unit containing a parameter set is an picture parameter set, PPS, logical unit.

According to another aspect of the invention, there is provided a method of generating a file comprising a bitstream of logical units of encoded video data comprising pictures, pictures being divided into picture portions, picture portions being grouped into picture portion groups, the method comprising:
encoding the bitstream according to the invention;
generating a first track comprising the logical units containing the parameter sets, and the rewriting information;
generating for a picture portion group, a track containing the logical unit containing the picture portion group; and,
generating the file comprising the generated tracks.

According to another aspect of the invention, there is provided a bitstream of logical units, the bitstream comprising encoded video data comprising pictures, pictures being divided into picture portions, picture portions being grouped into picture portion groups, the bitstream comprising:
a first logical unit comprising a picture portion group encoded as a picture portion group header and a picture portion group encoded video data, the picture portion group header comprising at least one identifier of a logical unit containing a parameter set;
the logical unit containing the parameter set; and,
a logical unit comprising rewriting information comprising a new value of the identifier of the logical unit containing the parameter set.

According to another aspect of the invention, there is provided a computer program product for a programmable apparatus, the computer program product comprising a sequence of instructions for implementing a method according to the invention, when loaded into and executed by the programmable apparatus.

According to another aspect of the invention, there is provided a computer-readable storage medium storing instructions of a computer program for implementing a method according to the invention.

According to another aspect of the invention, there is provided a computer program which upon execution causes the methods of the invention to be performed.

At least parts of the methods according to the invention may be computer implemented. Accordingly, the present invention may take the form of an entirely hardware embodiment, an entirely software embodiment (including firmware, resident software, microcode, etc.) or an embodiment combining software and hardware aspects that may all generally be referred to herein as a “circuit”, “module” or “system”. Furthermore, the present invention may take the form of a computer program product embodied in any tangible medium of expression having computer usable program code embodied in the medium.

Since the present invention can be implemented in software, the present invention can be embodied as computer-readable code for provision to a programmable apparatus on any suitable carrier medium. A tangible, non-transitory carrier medium may comprise a storage medium such as a floppy disk, a CD-ROM, a hard disk drive, a magnetic tape device or a solid-state memory device and the like. A transient carrier medium may include a signal such as an electrical signal, an electronic signal, an optical signal, an acoustic signal, a magnetic signal or an electromagnetic signal, e.g. a microwave or RF signal.

### BRIEF DESCRIPTION OF DRAWINGS

Embodiments of the invention will now be described, by way of example only, and with reference to the following drawings in which:

FIGS. 1a and 1b illustrate two different application examples for the combination of regions of interest;

FIGS. 2a, 2b, and 2c illustrate some partitioning in encoding systems;

FIG. 3 illustrates the organisation of the bitstream in the exemplary coding system VVC;

FIG. 4 illustrates an example of process of generating a video bitstream composed of different regions of interest from one or several original bitstreams;

FIG. 5 illustrates issues with APS NAL unit when merging slices form different bitstreams;

FIG. 6 illustrates the main steps of an encoding process according to an embodiment of the invention;

FIG. 7 illustrates the main steps of a decoding process according to an embodiment of the invention;

FIG. 8 illustrates the extraction and merge operation of two bitstreams stored in a file to form a resulting bitstream stored in a resulting file in an embodiment of the invention;

FIG. 9 illustrates the main step of the extraction and merge process at file format level in an embodiment of the invention;

FIG. 10 illustrates a schematic block diagram of a computing device for implementation of one or more embodiments of the invention.

### DETAILED DESCRIPTION OF THE INVENTION

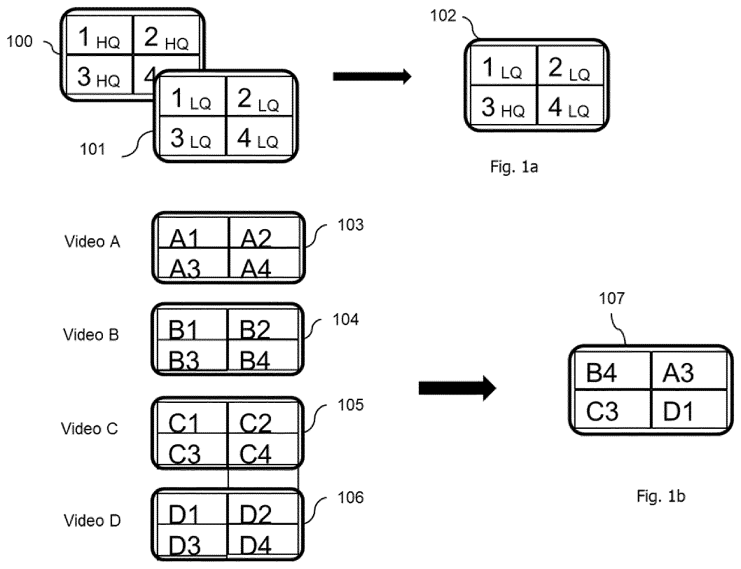

FIGS. 1a and 1b illustrate two different application examples for the combination of regions of interest.

For instance, FIG. 1a illustrates an example where a picture (or frame) 100 from a first video bitstream and a picture 101 from a second video bitstream are merged into a picture 102 of the resulting bitstream. Each picture is composed of four regions of interest numbered from 1 to 4. The picture 100 has been encoded using encoding parameters resulting in a high quality encoding. The picture 101 has been encoded using encoding parameters resulting in a low quality encoding. As well known, the picture encoded with a low quality is associated with a lower bitrate than the picture encoded with a high quality. The resulting picture 102 combines the regions of interest 1, 2 and 4 from the picture 101, thus encoded with a low quality, with the region of interest 3 from picture 100 encoded with a high quality. The goal of such combination is generally to get a region of interest, here the region 3, in high quality, while keeping the resulting bitrate reasonable by having regions 1, 2 and 4 encoded in low quality. Such kind of scenario may happen in particular in the context of omnidirectional content allowing a higher quality for the content actually visible while the remaining parts have a lower quality.

FIG. 1b illustrates a second example where four different videos A, B, C and D are merged to form a resulting video. A picture 103 of video A is composed of regions of interest A1, A2, A3, and A4. A picture 104 of video B is composed of regions of interest B1, B2, B3, and B4. A picture 105 of video C is composed of regions of interest C1, C2, C3, and C4. A picture 106 of video D is composed of regions of interest D1, D2, D3, and D4. The picture 107 of the resulting video is composed by regions B4, A3, C3, and D1. In this example, the resulting video is a mosaic video of different regions of interest of each original video stream. The regions of interest of the original video streams are rearranged and combined in a new location of the resulting video stream.

The compression of video relies on block-based video coding in most coding systems like HEVC, standing for High Efficiency Video Coding, or the emerging VVC, standing for Versatile Video Coding, standard. In these encoding systems, a video is composed of a sequence of frames or pictures or images or samples which may be displayed at several different times. In the case of multi layered video (for example scalable, stereo, 3D videos), several pictures may be decoded to compose the resulting image to display at one instant. A picture can be also composed of different image components. For instance, for encoding the luminance, chrominances or depth information.

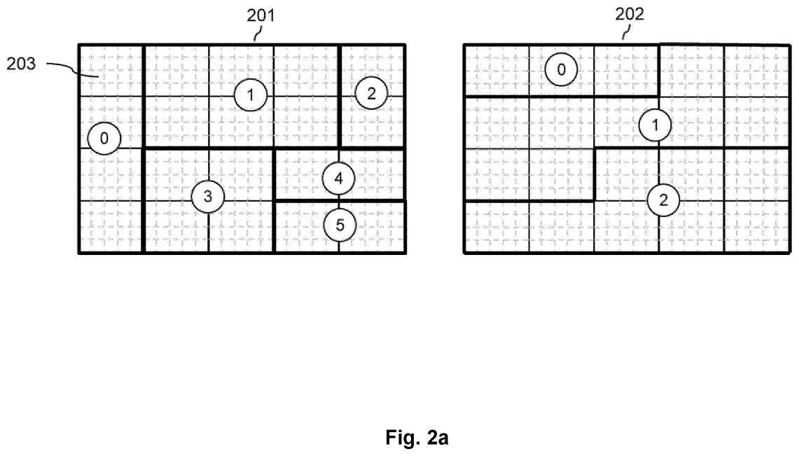

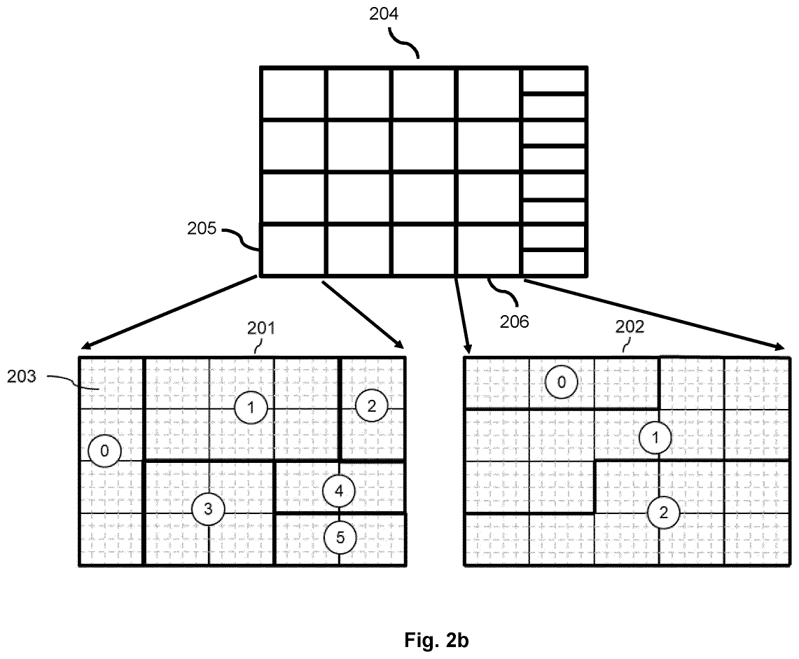

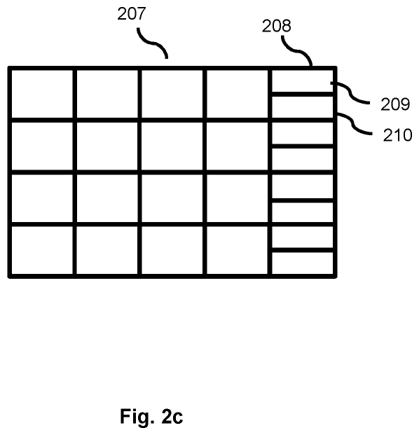

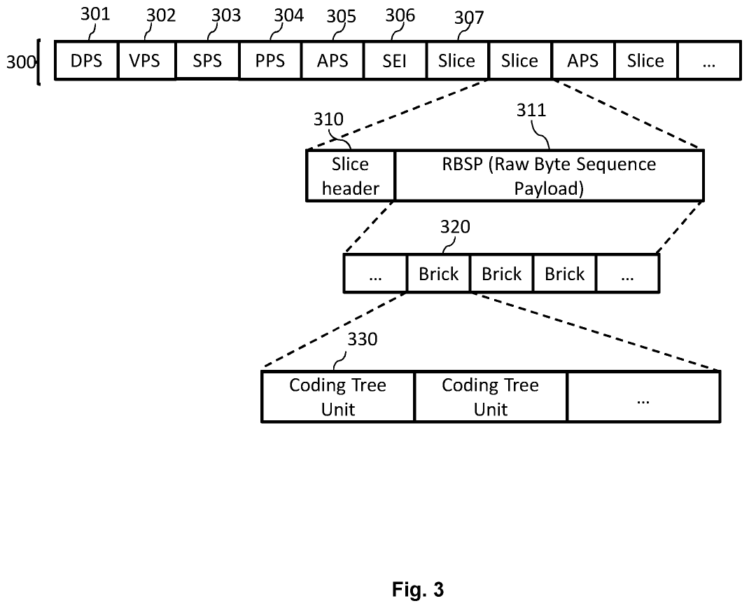

The compression of a video sequence relies on several partitioning techniques for each picture. FIG. 2 illustrates some partitioning in encoding systems. The pictures 201 and 202 are divided in coded tree units (CTU) illustrated by the dotted lines. A CTU is the elementary unit of encoding and decoding. For example, the CTU can encode an area of 128 by 128 pixels.

A Coding Tree Unit (CTU) could also be named block, macro block, coding unit. It can encode simultaneously the different image components or it can be limited to only one image component.

As illustrated by FIG. 2a, the picture can be partitioned according to a grid of tiles, illustrated by the thin solid lines. The tiles are picture parts, thus regions of pixels that may be defined independently of the CTU partitioning. The boundaries of tiles and the boundaries of the CTU may be different. A tile may also correspond to a sequence of CTUs, as in the represented example, meaning that the boundaries of tiles and CTUs coincide.

Tiles definition provides that tile boundaries break the spatial encoding dependencies. This means that encoding of a CTU in a tile is not based on pixel data from another tile in the picture.

Some encoding systems, like for example VVC, provide the notion of slices. This mechanism allows the partitioning of the picture into one or several groups of tiles. Each slice is composed by one or several tiles. Two different kinds of slices are provided as illustrated by pictures 201 and 202. A first mode of slice partitioning is restricted to slice forming a rectangular area in the picture. Picture 201 illustrates the portioning of a picture into five different rectangular slices. A second mode of slice partitioning is restricted to successive tiles in raster scan order. Picture 202 illustrates the partitioning of a picture into three different slices composed of successive tiles in raster scan order. Rectangular slice mode is a structure of choice for dealing with regions of interest in a video. A slice can be encoded in the bitstream as one or several NAL units. A NAL unit, standing for a Network Abstraction Layer unit, is a logical unit of data for the encapsulation of data in the encoded bitstream. In the example of VVC encoding system, a slice is encoded as a single NAL unit. When a slice is encoded in the bitstream as several NAL units, each NAL unit of the slice is a Slice Segment. A slice segment includes a slice segment header that contains the coding parameters of the slice segment. The header of the first segment NAL unit of the slice contains all the coding parameters of the slices. The slice segment header of the subsequent NAL units of the slice may contains less parameters than the first NAL unit. In such a case, the first slice segment is an independent slice segment and the subsequent segments are dependent slice segments.

In OMAF v2 ISO/IEC 23090-2, a sub picture is a spatial part of a picture that represents a spatial subset of the original video content, which has been split into spatial subsets before video encoding at the content production side. A sub picture is for example one or more slices.

FIG. 2b illustrates an example of partitioning of a picture in sub pictures. A sub picture represents a picture spatial part that covers a rectangular region of a picture. Each sub picture may have different sizes and coding parameters. For instance, different tile grids and slices partitioning may be defined for each sub picture. Tiles represents portions of the picture. Slices are portion groups. In FIG. 2b, the picture 204 is subdivided in 24 sub pictures including the sub pictures 205 and 206. These two sub pictures further describe a tile grid and a partitioning in slice similar to the picture 201 and 202 of FIG. 2.

In a variant, rather than considering sub pictures, a picture could be partioned into several regions that may be independently coded as layers (e.g a VVC or HEVC layers). We may refer to such layer as “sub picture layer” or “region layer”. Each sub picture layer could be independently coded. When combined, the pictures of the sub picture layers may form a new picture of greater size equal to the size of the combination of the sub picture layers. In other word, on one hand, a picture may be spatially divided into sub pictures, each sub picture defining a grid of tiles and being spatially divided into slices. Moreover, on another hand, a picture may be divided into layers, each layer defining a grid of tiles and being spatially divided into slices. Tiles and slices may be defined at the picture level, at the sub picture level, or at the layer level. The invention will apply to all these configurations.

FIG. 2c illustrates an example of partitioning using brick partitioning. Each tile may comprise a set of bricks. A brick is a contiguous set of CTUs forming one line in the tile. For example, the frame 207 of the FIG. 2c is divided into 20 tiles. Each tile contains exactly one brick except the ones at the rightmost column of tiles that contain two bricks per tile. For instance, the tile 208 contains two bricks 209 and 210. When bricks partitioning is employed, the slice contains either bricks from one tiles or several bricks from other tiles. In other word, the VCL NAL units are a set of bricks instead of a set of tiles. A picture is divided into picture portions that may be tiles or bricks. The slices are picture portion groups, therefore groups of tiles or groups of bricks.

This invention applies to any kinds of partitioning approach (including tiles, bricks, sub-picture partitioning).

FIG. 3 illustrates the organisation of the bitstream in the exemplary coding system VVC.

A bitstream 300 according to the VVC coding system is composed of an ordered sequence of syntax elements and coded data. The syntax element and coded data are placed into NAL unit 301-307. There are different NAL unit types. The network abstraction layer provides the ability to encapsulate the bitstream into different protocols, like RTP/IP, standing for Real Time Protocol/Internet Protocol, ISO Base Media File Format, etc. The network abstraction layer also provides a framework for packet loss resilience.

NAL units are divided into VCL NAL units and non-VCL NAL units, VCL standing for Video Coding Layer. The VCL NAL units contain the actual encoded video data. The non-VCL NAL units contain additional information. This additional information may be parameters needed for the decoding of the encoded video data or supplemental data that may enhance usability of the decoded video data. NAL units 307 correspond to slice (or slice segment when present) and constitute the VCL NAL units of the bitstream. Different NAL units 301-306 correspond to different parameter sets and supplemental enhancement information (SEI), these NAL units are non-VCL NAL units. The VPS NAL unit 302, VPS standing for Video Parameter Set, contains parameters defined for the whole video, and thus the whole bitstream. The DPS (that stands for Decoder Parameter Set) NAL unit 301 may define parameters more static than the parameters in the VPS. In other word, the parameters of DPS change less frequently than the parameter of the VPS. The SPS NAL unit 303, SPS standing for Sequence Parameter Set, contains parameters defined for a video sequence. In particular, the SPS NAL unit may define the sub pictures of the video sequences. The syntax of the SPS contains for example the following syntax elements:

| | Descriptor |
|---|---|
| seq_parameter_set_rbsp( ) { | |
| sps_max_sub_layers_minus1 | u(3) |
| sps_reserved_zero_5bits | u(5) |
| profile_tier_level( sps_max_sub_layers_minus1 ) | |
| sps_seq_parameter_set_id | ue(v) |
| [...] | |
| num_sub_pics_minus1 | ue(v) |
| sub_pic_id_len_minus1 | ue(v) |
| if( num_sub_pics_minus1 > 0 ) | |
| for ( i = 0; i <= num_sub_pics_minus1; i++ ) { | |
| sub_pic_id[ i ] | u(v) |
| if( num_sub_pics_minus1 > 0 ) { | |
| sub_pic_treated_as_pic_flag[ i ] | u(1) |
| sub_pic_x_offset[ i ] | ue(v) |
| sub_pic_y_offset[ i ] | ue(v) |
| sub_pic_width_in_luma_samples[ i ] | ue(v) |
| sub_pic_height_in_luma_samples[ i ] | ue(v) |
| } | |
| } | |
| [...] | |

The descriptor column gives the encoding of a syntax element, u(1) means that the syntax element is encoded using one bit, ue(v) means that the syntax element is encoded using unsigned integer 0-th order Exp-Golomb-coded syntax element with the left bit first that is a variable length encoding.

The syntax element num_sub_pics_minus1 specifies the number of sub pictures in a picture of the video sequence. Then, sub_pic_id_len_minus1 represents the number of bits used to encode the sub_pic_id[i] syntax elements. There are as many sub_pic_id[i] as sub pictures in each picture of the video sequence. The sub_pic_id[i] syntax element is an identifier of sub picture. The sub_pic_treated_as_pic_flag[i] syntax element indicates whether the sub picture boundaries should be treated as picture boundaries except for the loop filtering process. The sub_pic_x_offset[i], sub_pic_y_offset[i] specifies the location of the first pixel of the sub picture with reference to the picture referential. The sub_pic_width_in_luma_samples[i] and sub_pic_height_in_luma_samples[i] syntax elements indicate respectively the width and the height of the sub picture.

When using sub picture layer partitioning, the decoding layout of the different layers could be described in a Parameter Set unit such as the VPS or the DPS NAL units or in an SEI NAL unit. The identifier of the sub picture layer may be for example a NAL unit layer identifier. The embodiments described in this invention also apply to sub picture layers.

The PPS NAL unit 304, PPS standing for Picture Parameter Set, contains parameters defined for a picture or a group of pictures. The APS NAL unit 305, APS standing for Adaptation Parameter Set, contains parameters for loop filters typically the Adaptive Loop Filter (ALF) and the reshaper model (or luma mapping with chroma scaling model) that are defined at the slice level. The bitstream may also contain SEI NAL unit 306, standing for Supplemental Enhancement Information, NAL units.

The syntax of the SEI NAL unit consists of a set of SEI message elements. One SEI message contains a payload type syntax element (payload_type_byte in the table below) that specifies the type of the SEI message. Depending on this type, the SEI payload of the message contains a set of syntax elements. Parameters in the SEI payload provide additional information that may be used by a decoder or ignored when the payload type is unknown.

| | Descriptor |
|---|---|
| sei_message( ) { | |
| payloadType = 0 | |
| do { | |
| payload_type_byte | u(8) |
| payloadType += payload_type_byte | |
| } while (payload_type_byte == 0xFF ) | |
| payloadSize = 0 | |
| do { | |
| payload_size_byte | u(8) |
| payloadSize += payload_size_byte | |
| } while (payload_size_byte == 0xFF ) | |
| sei_payload( payloadType, payloadSize ) | |
| } | |

The periodicity of occurrence of these parameter sets in the bitstream is variable. A VPS that is defined for the whole bitstream needs to occur only once in the bitstream. At the opposite, an APS that is defined for a slice may occur once for each slice in each picture. Actually, different slices may rely on the same APS and thus there are generally fewer APS than slices in each picture. When a picture is divided into sub pictures, a PPS may be defined for each sub picture or a group of sub pictures.

The VCL NAL units 307 contain each a tile or a portion of tile. Typically, the VCL NAL units may corresponds to one slice or to a slice segment. FIG. 3 refers slice as example but applies also to slice segment. A slice may correspond to the whole picture or sub picture, a single tile or brick or a plurality of tiles or bricks. A slice is composed of a slice header 310 and a raw byte sequence payload, RBSP, 311 that contains the tiles or bricks.

The slice index is the index of the slice in the picture in raster scan order. For example, in FIG. 2, the number in a round represents the slice index for each slice. Slice 203 has a slice index of 0.

The slice identifier is a value, meaning an integer or any bit sequence, which is associated to a slice. Typically, the PPS contains the association for each slice between the slice index and the slice identifier for one or several pictures. For example, in FIG. 2, the slice 203 with slice index 0 can have a slice identifier of ‘345’.

The slice address is a syntax element present in the header of the slice NAL unit. The slice address may refer to the slice index, to the slice identifier or even to a brick or tile index. In the latter case, it will be the index of the first brick in the slice. The semantic of the slice address is defined by several flags present in one of the Parameters Set NAL units. In the example of slice 203 in FIG. 2, the slice address may be the slice index 0, the slice identifier 345 or the brick index 0.

The slice index, identifier and address are used to define the partitioning of the picture into slice. The slice index is related with the location of the slice in the picture. The decoder parses the slice address in the slice NAL unit header and uses it to locate the slice in the picture and determine the location of the first sample in the NAL unit. When the slice address refers to the slice identifier, the decoder uses the association indicated by the PPS to retrieve the slice index associated with the slice identifier and thus determine the location of the slice and of the first sample in the NAL unit.

The syntax of the PPS as proposed in the current version of VVC is as follows:

| | Descriptor |
|---|---|
| pic_parameter_set_rbsp( ) { | |
| pps_pic_parameter_set_id | ue(v) |
| pps_seq_parameter_set_id | ue(v) |
| output_flag_present_flag | u(1) |
| single_tile_in_pic_flag | u(1) |
| if( !single_tile_in_pic_flag ) { | |
| uniform_tile_spacing_flag | u(1) |
| if( uniform_tile_spacing_flag ) { | |
| tile_cols_width_minus1 | ue(v) |
| } else { | |
| num_tile_columns_minus1 | ue(v) |
| } | |
| brick_splitting_present_flag | u(1) |
| for( i = 0; i < NumTilesInPic; i++ ) { | |
| if(! uniform_tile_spacing_flag ) { | |
| tile_column_width_minus1[ i ] | ue(v) |
| } | |
| if (brick_splitting_present_flag && i > 0) { | |
| reuse_brick_split_pattern[ i ] | u(1) |
| if(reuse_brick_split_pattern[ i ]) | |
| reuse_brick_split_column_idx [ i ] | ue(v) |
| if(brick_splitting_present_flag && !reuse_brick_split_pattern[ i ]) { | |
| brick_split_flag[ i ] | |
| if(!brick_split_flag[ i ]) { | |
| uniform_brick_spacing_flag[ i ] | u(1) |
| if( uniform_brick_spacing_flag[ i ] ) | |
| brick_height_minus1[ i ] | ue(v) |
| else { | |
| num_brick_rows_minus1[ i ] | ue(v) |
| for( j = 0; j < num_brick_rows_minus1[ i ]; j++ ) | |
| brick_row_height_minus1[ i ][ j ] | ue(v) |
| } | |
| } | |
| } | |
| } | |
| single_brick_per_slice_flag | u(1) |
| if( !single_brick_per_slice_flag ) | |
| rect_slice_flag | u(1) |
| if( rect_slice_flag && !single_brick_per_slice_flag ) { | |
| num_slices_in_pic_minus1 | ue(v) |
| for( i = 0; i <= num_slices_in_pic_minus1; i++ ) { | |
| if( i > 0 ) | |
| top_left_brick_idx[ i ] | u(v) |
| bottom_right_brick_idx_delta[ i ] | u(v) |
| } | |
| } | |
| loop_filter_across_bricks_enabled_flag | u(1) |
| if( loop_filter_across_bricks_enabled_flag ) | |
| loop_filter_across_slices_enabled_flag | u(1) |
| } | |
| if( rect_slice_flag ) { | |
| signalled_slice_id_flag | u(1) |
| if( signalled_slice_id_flag ) { | |
| signalled_slice_id_length_minus1 | ue(v) |
| for( i = 0; i <= num_slices_in_pic_minus1; i++ ) | |
| slice_id[ i ] | u(v) |
| } | |
| } | |
| [...] // Additional syntax elements not represented | |
| rbsp_trailing_bits( ) | |
| } | |

The descriptor column gives the encoding of a syntax element, u(1) means that the syntax element is encoded using one bit, ue(v) means that the syntax element is encoded using unsigned integer 0-th order Exp-Golomb-coded syntax element with the left bit first that is a variable length encoding. The syntax elements num_tile_columns_minus1 and num_tile_rows_minus1 respectively indicate the number of tile columns and rows in the picture. When the tile grid is not uniform (uniform_tile_spacing_flag equal 0) the syntax element tile_column_width_minus1[ ] and tile_row_height_minus1[ ] specify the widths and heights of each column and rows of the tile grid.

The slice partitioning is expressed with the following syntax elements:

The syntax element single_tile_in_pic_flag states whether the picture contains a single tile. In other words, there is only one tile.

The syntax element single_brick_per_slice_flag states whether each slice contains a single brick. In other words, all the bricks of the picture belong to a different slice when this flag is true.

The syntax element rect_slice_flag indicates that slices of the pictures form a rectangular shape as represented in the picture 201.

When present, the syntax element num_slices_in_pic_minus1 is equal to the number of rectangular slices in the picture minus one.

Syntax elements top_left_brick_idx[ ] and bottom_right_brick_idx[ ] are arrays that respectively specify the first brick (top left) and the last (bottom right) brick in a rectangular slice. Theses arrays are indexed by slice index.

The slice identifiers are specified when the signalled_slice_id_flag is equal to 1. In this case, the signalled_slice_id_length_minus1 syntax element indicates the number of bits used to code each slice identifier value. The slice_id[ ] table is indexed by slice index and contains the identifier of the slice. When the signalled_slice_id_flag equal to 0 the slice_id is indexed by slice index and contains the slice index of the slice.

The slice header comprises the slice address according to the following syntax in the current VVC version:

| | Descriptor |
|---|---|
| slice_header( ) { | |
| slice_pic_parameter_set_id | ue(v) |
| if( rect_slice_flag \|\| NumBricksInPic > 1 ) | |
| slice_address | u(v) |
| if( !rect_slice_flag && !single_brick_per_slice_flag ) | |
| num_bricks_in_slice_minus1 | ue(v) |
| [...] | |

When the slice is not rectangular, the slice header indicates the number of bricks in the slice NAL unit with help of num_bricks_in_slice_minus1 syntax element.

Each brick 320 contains a set of encoded data corresponding to one or more coding unit data 340.

In a variant, the video sequence includes sub pictures; the syntax of the slice header may be the following:

| | Descriptor |
|---|---|
| slice_header( ) { | |
| slice_pic_parameter_set_id | ue(v) |
| slice_sub_pic_id | u(v) |
| if( rect_slice_flag \|\| NumBricksInSubPic > 1 ) | |
| slice_address | u(v) |
| [..] | |

The slice header includes the slice_sub_pic_id syntax element which specifies the identifier (i.e. corresponding to one of the sub_pic_id[i] defined in the SPS) of the sub pictures it belongs to. As a result, all the slices that share the same slice_sub_pic_id in the video sequence belong to the same sub picture.

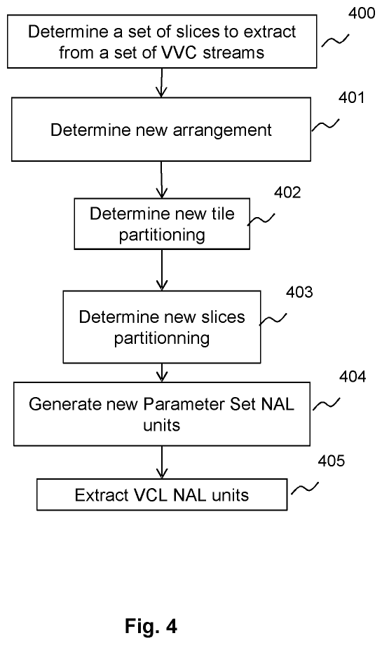

FIG. 4 illustrates the process of generating a video bitstream composed of different regions of interest from one or several original bitstreams.

In a step 400, the regions to be extracted from the original bitstreams are selected. The regions may correspond for instance to a specific region of interest or a specific viewing direction in an omnidirectional content. The slices comprising encoded samples present in the selected set of regions are selected in the original bitstreams. At the end of this step, the identifier of each slice in the original bitstreams, which will be merged in the resulting bitstreams, is determined. For example, the identifiers of the slices 1, 2, and 4 of picture 101 and of the slice 3 of picture 100 in FIG. 1 are determined.

In a step 401, a new arrangement for the selected slices in the resulting video is determined. This consists in determining the size and location of each selected slices in the resulting video. For instance, the new arrangement conforms to a predetermined ROI composition. Alternatively, a user defines a new arrangement.

In a step 402, the tile and brick partitioning of the resulting video needs to be determined. When the tile and brick partitioning of the original bitstreams are identical, the same tile and brick partitioning is kept for the resulting video. At the end of this step, the number of rows and columns of the tile grid with the width and height of the tiles is determined and, advantageously stored in memory. Similarly, the sizes of the bricks are determined and stored in memory.

When determining the new arrangement, determined in step 401, of the slice groups in the resulting video, the location of a slice in the video may change regarding its location in the original video. In a step 403, the new locations of the slices are determined. In particular, the slice partitioning of the resulting video is determined. The location of the slices are determined in reference with the new tile grid and brick partitioning as determined in step 402.

In a step 404, new parameters sets are generated for the resulting bitstream. In particular, new PPS NAL units are generated. These new PPS contains syntax elements to encode the tile grid and brick partitioning, the slice partitioning and positioning and the association of the slice identifier and the slice index. To do so, the slice identifier is extracted from each slice and associated with the slice index depending of the new decoding location of the slice. It is reminded that each slice, in the exemplary embodiment, is identified by an identifier in the slice header and that each slice identifier is associated with an index corresponding to the slice index of the slice in the picture in raster scan order. This association is stored in a PPS NAL unit. Assuming that there is no collision in the identifiers of the slices, when changing the position of a slice in a picture, and thus changing the slice index, there is no need to change the slice identifiers and thus to amend the slice structure. Only PPS NAL units need to be amended.

In a step 405, the VCL NAL unit, namely the slices, are extracted from the original bitstreams to be inserted in the resulting bitstream. It may happen that these VCL NAL units need to be amended. In particular, some parameters in slice headers may not be compatible with the resulting bitstream and need to be amended. It would be advantageous to provide a solution to avoid an actual rewriting of the slice headers in the merging process while avoiding parameters incompatibilities.

In particular, APS NAL units may generate a need to amend slice headers. It is reminded that APS stores the parameters needed for the loop filtering (e.g. ALF and reshaper filter) of the picture. Each APS comprises an identifier to identify this APS. Each slice header comprises a flag that indicates if adaptive loop filtering is to be applied, and if this flag is true, the identifier of the APS containing the parameters to be used for adaptive loop filtering is stored in the slice header. In the current version of the standard, the APS identifier can take 32 values. Due to the low number of possible values, when merging slice from different bitstreams, there is a high risk of collision between these identifiers. Solving these collisions implies to change some APS identifiers and thus to amend the APS identifier in some slice headers.

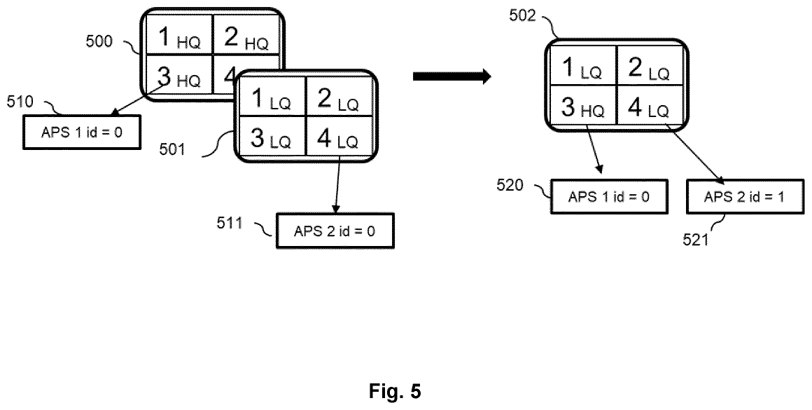

FIG. 5 illustrates issues with APS NAL unit when merging slices from different bitstreams.

Adaptive loop filtering (ALF) may be used as an in-loop filter for each picture. ALF requires the transmission of a set of parameters named ALF parameters. The ALF parameters are typically transmitted in a dedicated parameter set called APS for Adaptation Parameter Set. The APS is transmitted as a non-VCL NAL unit. It contains an identifier of the APS and the ALF parameters to be used in one or several slices of one or several pictures. The identifier is a value comprised in the range 0-31. The update mechanism is the following: when a new APS is received with a same identifier as a previous one, it replaces the previous one. The APS can change very rapidly, for each picture, the ALF parameters may be recomputed and new APS may be generated either as replacement or in addition to previous ones. The APS may comprise data for other loop filters such as the luma mapping chroma scaling (LMCS) filtering (also known as reshaper). Each APS includes a syntax element that specifies if the APS contains parameters for ALF or LMCS filters. The APS may typically take the following syntax:

| | Descriptor |
|---|---|
| adaptation_parameter_set_rbsp( ) { | |
| adaptation_parameter_set_id | u(5) |
| aps_params_type | u(3) |
| if( aps_params_type == ALF_APS ) // 0 | |
| alf_data( ) | |
| else if ( aps_params_type == LMCS_APS ) // 1 | |
| lmcs_data( ) | |
| [...] | |
| } | |

A slice header comprises a flag, typically called slice_alf_enabled_flag, to indicate if the ALF filter is used. When ALF filter is used, the slice header comprises the identifier of the APS to be used. In each successive picture, a slice with the same index is likely to change its APS identifier. These syntax elements of the slice header are typically encoded according to the following syntax:

| | Descriptor |
|---|---|
| slice_header( ) { | |
| ... | |
| if( sps_alf_enabled_flag ) { | |
| slice_alf_enabled_flag | u(1) |
| if( slice_alf_enabled_flag ) { | |
| num_alf_aps_ids_minus1 | ue(v) |
| for( i = 0; i <= num_alf_aps_ids_minus1; i++ ) | |
| slice_alf_aps_id[ i ] | u(5) |
| } | |
| } | |
| ... | |
| if( sps_lmcs_enabled_flag ) { | |
| slice_lmcs_enabled_flag | u(1) |
| if( slice_lmcs_enabled_flag ) { | |
| slice_lmcs_aps_id | |
| } | |

The slice header may include several APS identifiers typically one (or more) for the ALF and one for the LMCS or Reshaper filter. For example, the identifier for the ALF filter is named slice_alf_aps_id and the identifier for the LMCS is named slice_lmcs_aps_id. All the embodiments described below apply the same way to all the APS identifiers described in the slice header.

When merging different slices from different bitstreams, this design generates a possibility of collision between the APS identifiers. FIG. 5 illustrates an example of such collision. In FIG. 5, the slice 3 of a first bitstream 500 refers to an APS 510 having an identifier with the value 0 in bitstream 500. The slice 4 in a second bitstream 501 also refers to an APS 511 having an identifier having the value 0 in bitstream 501. APS 510 and APS 511, while having the same identifier “0”, are likely to contain different ALF parameters as they are defined in different bitstreams.

When generating the resulting bitstream 502, it is necessary to modify the identifier of at least one of the APS 520 and 521 in order to provide each slice with the right ALF parameters. In the example, APS 521 corresponds to APS 511 with an amended identifier now taking the value “1”. To do so, it is necessary to read, decode, amend and re-encode the APS 521 with the new identifier. This is not a too complex operation as APS are relatively small NAL units with mainly fixed variable length elements. It is also necessary to change the APS identifier referenced in the header of the slice 4 to correctly reference the APS 521 with its new identifier. This is a much more complex operation as the slice header is a complex structure with many variable length elements. This means that the complete header needs to be decoded, amended and re-encoded, especially since the APS identifier is encoded in the last part of the slice header. In particular, it may be complex fora decoder to track the different APS identifier collision.

In order to improve the merging operation, it may be contemplated to amend the structure of the slice header. For example, the APS identifiers may be encoded at the beginning of the slice header using a fixed length syntax element. By doing so, the rewriting of the slice header would only need to decode these first syntax elements, to amend it and then to copy the rest of the slice header. However, this copy would still be a costly operation due to the size of the slice header and the slice payload.

It may also be contemplated to increase the range of possible values for the APS identifier. The length of the APS identifier field could be indicated in the PPS. With this improvement, it would be possible for several communicating encoders to use different sub ranges of APS identifiers for encoding bitstreams in order to allow the merge of slices from these bitstreams with no collision in APS identifiers. However, this solution has some drawbacks. It increases the number of bits needed for the encoding of the APS identifier that is present in each slice, so typically several times per picture. This implies a decrease of the compression ratio, which is not desirable. It may also be contemplated to generate randomly the APS identifiers in order to decrease the risk of collision. However, due to the high number of APS needed to encode a typical bitstream, in particular when multiple ALF parameters sets and LMCS parameter applies in the picture, it is unlikely to solve entirely the collision problem.

According to an embodiment of the invention, the merge operation generates new NAL units, or amend some existing ones, that specify the rewriting of the APS and the slice header to avoid APS identifier collisions.

According to this embodiment, the merge operation comprises the insertion of slice header rewriting information SEI NAL unit to rewrite both the APS with conflicted APS identifier and the corresponding APS identifier in the slice headers.

According to embodiments, the rewriting of the APS NAL unit may be done during the merge operation and only the slice header is rewritten at decoding according to the rewriting information. In some embodiments, rewriting information allows rewriting both the APS NAL units and the slice header at decoding.

At decoding, when decoding a slice, the decoder needs to identify the right APS corresponding to the slice. It consists in amending/rewriting the APS identifier decoded from the slice header with a new value from the slice header rewriting information SEI NAL unit. This solution simplifies the rewriting of the slice header since the merging operation does not have necessarily to rewrite all the slice headers to modify the collided APS identifiers in the merge stream. The insertion of SEI message makes it possible for the decoder to amend the APS identifiers in the slice headers on the fly while actually performing the decoding of the headers of the slice NAL units.

In an embodiment, the rewriting information only contains the initial and the new value of the APS identifiers and applies to the slice header of the first slice NAL unit following the rewriting information in the bitstream. In some embodiments, the rewriting information only contains the new APS identifier and applies to the first APS NAL unit following the rewriting information in the bitstream. In some embodiments, the rewriting information contains the identifier of the targeted slice associated with the new value of the APS identifier. In other embodiments, the rewriting information contains both the initial value of the APS identifier and the new value of this identifier associated or not with a slice identifier.

In a first example of an embodiment, the slice header rewriting information is implemented as an SEI NAL unit. This SEI information contains a set of rewriting information that associates one slice identifier with a set of APS identifiers. In particular, it indicates new identifier values for a set of APS identifiers specified in the slice header with a slice address equal to the slice identifier of the SEI information. For example, an initial APS identifier value is associated with a rewritten APS identifier value. As a result, the rewriting information sets form directives to rewrite the APS identifiers in slice header.

The syntax of the SEI information can be, for example:

| | Descriptor |
|---|---|
| slice_header rewriting_sets ( payloadSize ) { | |
| num_slice_rewriting_sets_minus1 | ue(v) |
| for( i = 0; i <= num_slice_rewriting_sets_minus1; i++ ) { | u(1) |
| rewrite_slice_id[ i ] | ue(v) |
| num_aps_id_rewritten_minus1 [ i ] | ue(v) |
| for( j = 0; j <= num_aps_id_rewritten_minus1[ i ]; j++ ) { | |
| initial_aps_id[ i ][ j ] | u(5) |
| rewriten_aps_id[ i ][ j ] | u(5) |
| } | |
| } | |
| } | |

The semantics of the syntax elements is the following:

num_slice_rewriting_sets_minus1 plus 1 specifies the number of rewriting slices information sets present in the SEI message.

rewrite_slice_id[i] specifies the slice address of the slice NAL unit for which APS identifier would be modified by the i-th rewriting slice information set.

num_aps_id_rewritten_minus1[i] plus 1, specifies the number of rewritten APS identifiers in the i-th rewriting slice information set.

initial_aps_id[i][j] specifies the j-th APS identifier of the i-th rewriting slice information set that is replaced by rewritten_aps_id[i][j].

rewritten_aps_id[i][j] specifies the j-th APS identifier of the i-th rewriting slice information set that replaces APS identifier equal to initial_aps_id[i][j].

As a result, when decoding the slice header with slice_address equal to rewrite_slice_id[i], all the slice_alf_aps_id and slice_lmcs_aps_id equal to initial_aps_id[i][j] shall be inferred equal to rewritten_aps_id[i][j].

In other words, this SEI message makes it possible to infer new APS identifiers values for some or all the APS identifiers when decoding slice headers with collided APS identifiers.

In another embodiment, the SEI message semantics is modified to a syntax closer to the slice header syntax. Although more verbose than the previous one, it advantageously makes it possible for a merge operation to amend directly the slice header with a set of consecutive bytes from the SEI message. The merge operation may need to rewrite the slice header when the decoder is not supporting the rewriting SEI message. This optional step is needed only for legacy decoders. For other decoder, it mainly consists in modifying the buffer in the memory of the decoder that contains the encoded data of the slice headers.

The syntax of the SEI information is for example the following:

| | Descriptor |
|---|---|
| slice_header rewriting_sets (payloadSize) { | |
| num_slice_rewriting_sets_minus1 | ue(v) |
| for( i = 0; i <= num_slice_rewriting_sets_minus1; i++ ) { | |
| rewrite_slice_id[ i ] | ue(v) |
| rewrite_alf_aps_id_flag | u(1) |
| if (rewrite_alf_aps_id_flag) { | |
| num_alf_aps_id_rewritten_minus1 [ i ] | ue(v) |
| for( j = 0; j <= num_aps_id_rewritten_minus1[ i ]; j++ ) { | |
| rewrite_slice_alf_aps_id[ i ][ j ] | u(5) |
| } | |
| } | |
| rewrite_lmcs_aps_id_flag | u(1) |
| if (rewrite_alf_aps_id_flag) { | |
| rewrite_slice_lmcs_aps_id[ i ] | u(5) |
| } | |
| } | |
| } | |

The SEI information includes syntax elements (prefixed by rewrite_) that correspond to syntax elements of the slice header. In other words, sets of syntax elements of SEI information form a data block. Similar data block can be found in the slice header. These syntax elements specify APS identifiers in the slice header. A decoder or a bitstream merger may copy the payload of the rewriting information set to replace the syntax elements of the slice header that include APS identifier.

The semantic of the new syntax element is the following:

num_slice_rewriting_sets_minus1 plus 1 specifies the number of rewriting slice information sets present in the SEI message.

rewrite_slice_id[i] specifies the slice address of the slice NAL unit for which APS identifier would be modified by the i-th rewriting slice information set.

rewrite_alf_aps_id_flag equal to 1 indicates the presence of the num_alf_aps_rewritten_minus1[i] and rewrite_slice_alf_aps_id[i][j]. When equal to 0, it indicates the absence of the num_alf_aps_rewritten_minus1[i] and rewrite_slice_alf_aps_id[i][j]. In other words, this flag indicates whether some APS identifiers used for ALF parameters should be replaced.

num_alf_aps_rewritten_minus1[i] plus 1 specifies the number of APS identifiers that will be modified by the i-th rewriting slice information set.

rewrite_slice_alf_aps_id[i][j] indicates the new values of the j-th APS identifier for ALF of the slice with slice address equal to rewrite_slice_id[i].

The value of num_alf_aps_rewritten_minus1[i] shall be equal to num_alf_aps_ids_minus1 of the slice with slice address equal to rewrite_slice_id[i]. As a result, if only a subset of the identifiers of the slice header are collided with another slice, some of the initial identifiers of the slice header and the rewritten ones may be identical. This permits during decoding or merging operation to amend this slice header by replacing the slice_alf_aps_id array with the new rewrite_slice_alf_aps_id values. The amending consists basically in a copy of the bits at the position of the first rewrite_slice_alf_aps_id[i][0] value for a size of num_alf_aps_rewritten_minus1[i] multiplied by the size of each rewrite_slice_alf_aps_id syntax element typically 5 bits. In a variant, the SEI message may include an offset for each rewriting information sets that corresponds to the location in bits or bytes (when byte aligned) of the syntax element that should be rewritten. One offset is defined for each of type of APS NAL units, typically one for the ALF parameters and one for LMCS.

In a variant, the num_alf_aps_rewritten_minus1[i] value is different than num_alf_aps_ids_minus1 of the slice with slice address equal to rewrite_slice_id[i]. For example, this permits to reduce the size of SEI message, when only the first ALF APS identifiers of the slice identifier need to be rewritten. In such a case, the copy will modify only the first identifier. In the variant with the offset, it may be used to replace a subsequent identifier.

rewrite_lmcs_aps_id_flag[i] equal to 1 indicates the presence of rewrite_slice_lmcs_aps_id[i]. When equal to 0, it indicates the absence of rewrite_slice_lmcs_aps_id[i].

rewrite_slice_lmcs_aps_id[i] specifies the new value of slice_lmcs_aps_id (the APS identifier for LMCS) of the slice header with slice address equal to rewrite_slice_id[i].

As a result, when decoding the slice header with slice_address equal to rewrite_slice_id[i], the j-th value of slice_alf_aps_id shall be inferred equal to rewrite_slice_alf_aps_id[i][j] when present. Similarly, the slice_lmcs_aps_id shall be inferred equal to rewrite_slice_lmcs_aps_id[i].

In another embodiment, the slice header rewriting information SEI message includes a reference to a parameter set NAL unit. This parameter set NAL unit makes is possible to determine whether a loop filter is enabled. Typically, the identifier of the PPS NAL unit make it possible to determine the identifier of the SPS that contains the sps_alf_enabled_flag and sps_lmcs_enabled_flag flags that respectively specify if ALF and LMCS is used within the video sequence (thus, within the slice). As a result, the syntax elements for rewriting the APS identifier for one of the loop filter are not present in slice header rewriting information SEI message when the flag indicates that the loop filter is disabled. For example, when sps_alf_enabled_flag equals 0, the syntax element rewriten_slice_alf_aps_id is not present. Similarly, when sps_lmcs_enabled_flag equals 0, rewritten_slice_lmcs_aps_id is absent from the SEI message.

For example, the syntax of slice header rewriting information SEI information is the following:

| | Descriptor |
|---|---|
| slice_header rewriting_sets (payloadSize) { | |
| slice_aps_rewriting_pic_parameter_set_id | ue(v) |
| num_slice_rewriting_sets_minus1 | ue(v) |
| for( i = 0; i <= num_slice_rewriting_sets_minus1; i++ ) { | |
| rewrite_slice_id[ i ] | ue(v) |
| if (sps_alf_enabled_flag) { | |
| rewrite_alf_aps_id_flag | u(1) |
| if (rewrite_alf_aps_id_flag) { | |
| num_alf_aps_id_rewritten_minus1 [ i ] | ue(v) |
| for( j = 0; j <= num_aps_id_rewritten_minus1[ i ]; j++ ) { | |
| rewriten_slice_alf_aps_id[ i ][ j ] | u(5) |
| } | |
| } | |
| } | |
| if (sps_lmcs_enabled_flag) { | |
| rewrite_lmcs_aps_id_flag | u(1) |
| if (rewrite_alf_aps_id_flag) { | |
| rewriten_slice_lmcs_aps_id[ i ][ j ] | u(5) |
| } | |
| } | |
| } | |
| } | |

The semantics of the new SEI message syntax elements is the following:

slice_aps_rewriting_pic_parameter_set_id specifies the value of pps_pic_parameter_set_id for the PPS in use. The value of slice_aps_rewriting_pic_parameter_set_id shall be in the range of 0 to 63, inclusive.

Values of sps_alf_enabled_flag, and of sps_lmcs_enabled_flag, are found in the SPS parameter set referred by the PPS identified by slice_aps_rewriting_pic_parameter_set_id.

Accordingly, the SEI message does not contain rewriting information when the ALF and/or LMCS are disabled.

In another embodiment, the rewriting of the APS identifier in the APS NAL unit consists in the insertion of new type of SEI message during merge operation. This SEI message named for instance adaptation parameter set rewriting information, is inserted prior to the APS NAL unit with a collided APS identifier.

The adaptation parameter set rewriting information includes rewriting directives to modify or to infer new values for APS identifier in APS NAL unit.

For example, the SEI message includes a first parameter (initial_adaptation_parameter_set_id) that indicates the identifier (i.e. adaptation_parameter_set_id syntax element of APS NAL unit) of the APS NAL unit that follows the SEI message in decoding order that should be amended. It also includes the new value (rewritten_adaptation_parameter_set_id) of the adaptation parameter set identifier that replaces the initial value.

For example, the syntax of the SEI message is the following:

| | Descriptor |
|---|---|
| adaptation_parameter_rewriting (payloadSize) { | |
| initial_adaptation_parameter_set_id | ue(v) |
| rewritten_adaptation_parameter_set_id | ue(v) |
| } | |

In a variant, the SEI message includes several APS rewriting information sets to amend several APS NAL units with a single SEI message. The SEI message includes a syntax element that specifies the number of APS rewriting information sets prior to the sets of rewriting information sets.

In a variant, the adaptation parameter set rewriting information is merged with slice rewriting information SEI message to form a new rewriting information set SEI message.

Accordingly, the APS NAL units do not have to be rewritten during the merge process, they can also be rewritten on the fly at decoding, similarly to the slice headers. By inserting the SEI message just before the APS NAL units to be rewritten, confusion on the actual NAL unit to be rewritten are avoided.

HEVC provided specific SEI messages to indicate a set of motion constrained tiles. In one embodiment, the rewriting information set SEI message applies to a set of slices that forms a motion-constrained region (e.g. a set of bricks, a set of slices or a set of tiles). In such a case, the rewriting information set SEI message may be present only when some NAL units define a motion-constrained region. In addition, if the motion-constrained region is represented by an identifier, the rewriting information SEI message may include a reference to this motion constrained region identifier.

For example, with sub-picture partitioning, the APS NAL units may apply to several sub pictures of the video sequence. In such a case, APS collisions may be observed. In addition, two slices from different sub-pictures may share the same slice address. The rewriting SEI message may thus include a reference to an identifier of subpicture (e.g. one of the sub_pic_id of the PPS) to precisely indicate which of the two slices should be rewritten.

In one embodiment, the SEI NAL unit that includes the rewriting information is a prefix SEI message meaning that it is provided prior to the VCL NAL units.

The activation period of the rewriting Information SEI message unit (i.e. the duration of validity of the SEI message) is the whole access unit to which the SEI belongs. In a variant, the SEI NAL unit is valid until replaced by a new rewriting information SEI message. This second variant advantageously make it possible to specify a single rewriting SEI message that will contains directives valid for the same slice for several frames.

In a variant, the rewriting information is provided in another non-VCL NAL unit type, for example BitstreamRewriting NAL unit. It can be also provided as a new Parameter Sets or as a new APS type.

For example, the rewriting information is provided as a new APS type (e.g. aps_params_type equal 2). The syntax of the APS NAL unit is for example the following:

| | Descriptor |
|---|---|
| adaptation_parameter_set_rbsp( ) { | |
| adaptation_parameter_set_id | u(5) |
| aps_params_type | u(3) |
| if( aps_params_type == ALF_APS ) // 0 | |
| alf_data( ) | |
| else if ( aps_params_type == LMCS_APS ) // 1 | |
| lmcs_data( ) | |
| else if (aps_params_type == NESTED_APS) //2 | |
| nested_aps_data( ) | |
| [...] | |
| } | |

This new APS NAL unit type contains the Raw Byte Sequence Payload of the initial APS (with the collided APS). The identifier, adaptation_parameter_set_id, of the new APS NAL unit (with aps_params_type equal 2) is the rewritten APS identifier of the initial APS NAL unit nested in the new APS NAL unit.

The syntax of the nested_aps_data( ) is for example the following:

| | Descriptor |
|---|---|
| nested_aps_data ( ) { | |
| rewritten_aps_rbsp_data_length | ue(v) |
| while( !byte_aligned( ) ) | |
| rewritten_aps_alignment_bit_equal_to_zero | f(1) |
| for(i = 0; i <= aps_rbsp_data_length; i++) | |
| rewritten_aps_rbsp_data[i] | u(8) |
| } | |

The semantics of the syntax element is the following:

rewritten_aps_rbsp_data_length is equal to the length in bytes of the initial APS embedded in the APS.

rewritten_aps_alignment_bit_equal_to_zero shall be equal zero. The purpose of this syntax element is to align rewritten_aps_rbsp_data syntax on byte.

rewritten_aps_rbsp_data[i] contains the i-th byte of the RBSP data of the initial APS.

In this embodiment, a new APS is defined, this new APS is identified with the new value of the APS identifier and contains, nested in the parameter set, a version of the initial APS.

In another example, the APS NAL unit may define a new type (e.g. equal to 3) to specifies the rewriting information for identifiers of the slice headers.

In another embodiment, similarly to APS identifiers, there is a risk of collision of Picture Parameter Set (PPS) identifiers in slice headers when merging different sub-pictures from two bitstreams. In such a case, the merge operation inserts Sub-Picture Rewritting Information SEI messages in the bitstream to provide rewriting directives or new inference mechanism of the PPS identifiers in the slice header. Similar syntaxes as in previous embodiments can be used. For example, the SEI message includes a parameter that indicates new identifier value for the PPS identifier specified in the slice header with a slice address equal to the slice identifier of the SEI message.

The present invention was described for APS identifiers that relates to ALF and LMCS loop filter, but could be extended to any identifiers of the slice header that refers to NAL unit with different types of parameters.

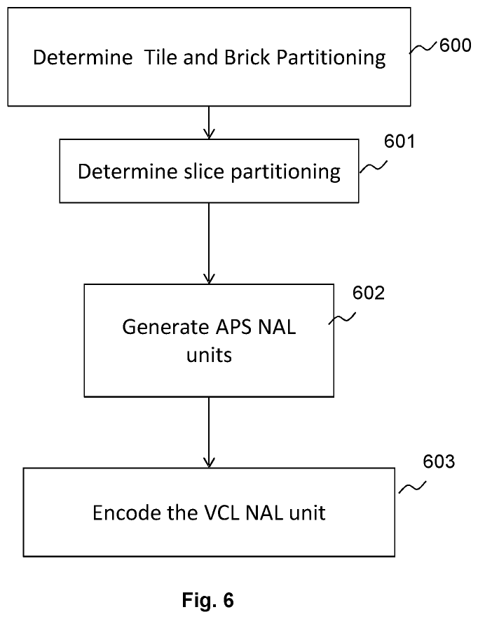

FIG. 6 illustrates the main steps of an encoding process according to an embodiment of the invention.

The described encoding process concerns the encoding according to an embodiment of the invention of a single bitstream. The obtained encoded bitstream may be used in a merging operation as described above as an initial bitstream or as the resulting bitstream.

In a step 600, a tile portioning of the pictures is determined. For instance, the encoder defines the number of columns and rows so that each region of interest of the video is covered by at least one tile. In another example, the encoder is encoding an omnidirectional video where each tile corresponds to a predetermined field of view in the video. The tile partitioning of the picture according to a tile grid is typically represented in a parameter set NAL unit, for example a PPS according to the syntax presented in reference to FIG. 3. In a variant, the step 600 further includes the partitioning of each tiles in bricks, for instance, to address more complex frame arrangements of the 360-degree content.

In a step 601, a set of slices are defined, each slice comprising one or more bricks. In a particular embodiment, a slice is defined for each tile of the picture. Advantageously, in order to avoid some VCL NAL unit rewriting in merge operation, a slice identifier is defined for each slice in the bitstream. The slice identifiers are determined in order to be unique for the slice. The unicity of the slice identifiers may be defined at the level of a set of bitstreams comprising the bitstream currently encoded.

The number of bits used to encode the slice identifier, corresponding to the length of the slice identifier, is determined as a function of the number of slices in the encoded bitstream or as a function of a number of slices in a set of different bitstreams comprising the bitstream being currently encoded.

The length of the slice identifier and the association of each slice with an identifier is specifically specified in parameter set NAL unit as the PPS.

In a step 602, each slice is associated to one or several APS when loop filtering is to be applied. The association comprises the insertion in the slice header of an APS. The identifier of the APS NAL units is set by incrementing the last identifier value to distinguish between the different APS NAL units.

In a step 603, the samples of each slice are encoded according to the parameters defined in the different parameter sets. In particular, the encoding will be based on the parameters in the APS associated with the slices. A complete bitstream is generated comprising both the non-VCL NAL units corresponding to the different parameter sets and the VCL NAL units corresponding to the encoded data of the different slices.

In an embodiment, the encoding process defines sub picture partitioning. When pictures are divided into sub pictures, merging of parts of pictures from different video sequences are based on sub pictures and not individual slices in these sub pictures. In such a case, the step 600 includes a preliminary step of determination of sub picture partitioning. Typically, the sub picture location and size is made to cover specific regions of interest. Following this preliminary step, each sub picture may be further divided into tiles and bricks as described previously in step 601 applying to the sub picture instead of the picture. In step 602, the association comprises the insertion in the slice header of one or several APS identifiers, one for each loop filter. The APS is generated with an APS identifier based on the APS identifier inserted in the slice header.

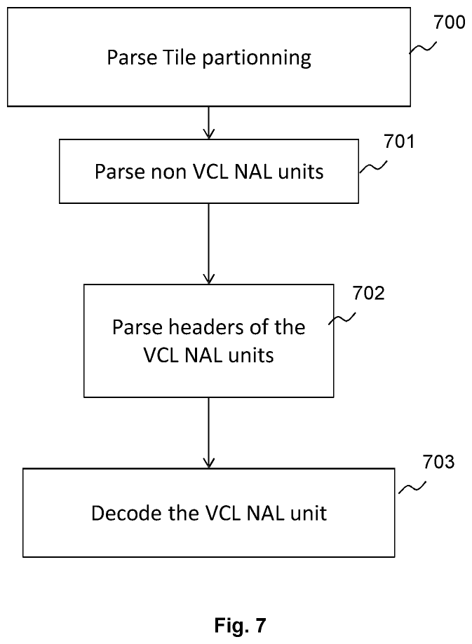

FIG. 7 illustrates the main steps of a decoding process according to an embodiment of the invention.

In a step 700, the decoder parses the bitstream in order to determine the tile and brick portioning of picture or each sub picture of the picture when present. This information is obtained from a parameter set NAL unit, typically from the PPS NAL unit. The syntax elements of the PPS are parsed and decoded to determine the grid of tiles and the brick arrangement.

In a step 701, the decoder decodes non-VCL NAL units to determine the slice partitioning of the picture and in particular obtain the number of slices associated with an identification information of each slice. This information is valid for at least one picture, but stay valid generally for many pictures. It may take the form of the slice identifier that may be obtained from a parameter set as the PPS NAL unit as described in FIG. 5.

In a variant, in a step 701 the decoder determines the number of slices associated with an identification information of each sub picture when present.

In step 701, the decoder parses the rewriting information from either Parameter Set NAL units or from SEI message. In particular, it determines the initial APS NAL unit for which the APS identifier should be rewritten. Then, it associate the rewritten identifier determined from the rewriting information with the initial APS NAL unit to form a new rewritten APS NAL unit. In practical, this forming operation may consist either in the creation of a new NAL unit that would replace the initial APS NAL unit or in modifying the identifier associated to the decoded data of the initial APS NAL unit stored in the decoder memory.

In one alternative, the APS have been rewritten prior to the decoding for instance during the merge operation that generates the input bitstream.

In a step 702, the decoder parses the header of each slice following the non-VCL NAL unit that includes rewriting information. When the slice address corresponds to one of the slice identifier specified in the non-VCL NAL unit, the decoder modifies the initial APS identifiers with rewritten APS identifier values accordingly to the rewriting directives of the rewriting information. The modification may consist in rewriting the payload of the slice headers prior to the decoding (in such a case the rewriting information may be removed from the bitstream) or by modifying the values of the APS identifiers of the slice stored in the decoder memory.

The decoder decodes the slice header encoded data with rewritten parameter sets identifiers to determine the correct identifier of the parameter set associated with the slice.

In a step 703, the decoder decodes the VCL NAL units corresponding to the slices according to the parameters determined in the previous steps. In particular, the decoding may include an adaptive loop filtering step with parameters obtained from the APS identified after rewriting operation made in the previous steps as being associated with the slice.

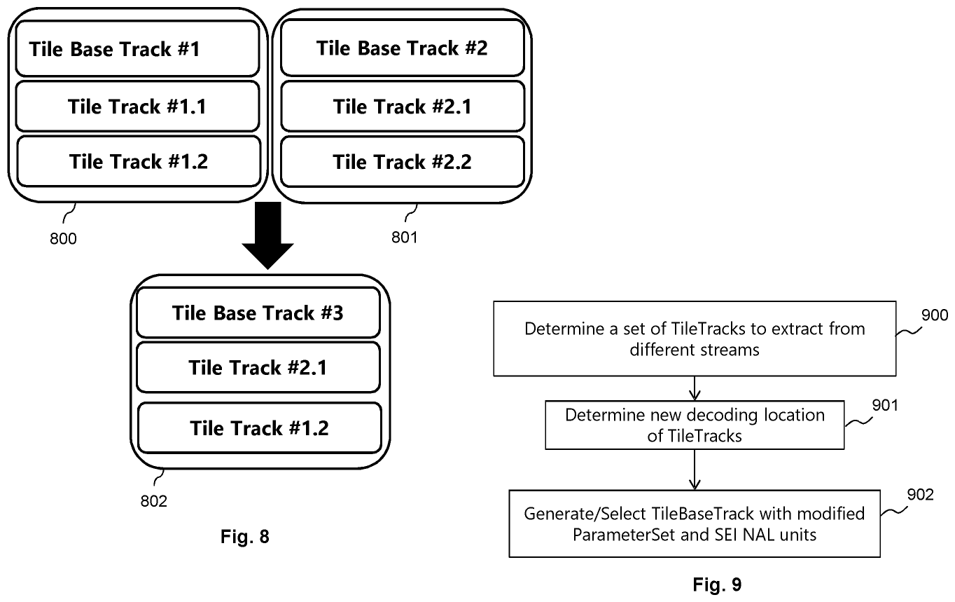

FIG. 8 illustrates the merge operation of two bitstreams stored in a file to form a resulting bitstream stored in a resulting file in an embodiment of the invention.

FIG. 9 illustrates the main step of the merge process at file format level in an embodiment of the invention.

FIG. 8 illustrates the merge of two ISO BMFF file 800 and 801 resulting in a new ISO BMFF file 802 according to the method of FIG. 9.

The encapsulation of the VVC streams consists in this embodiment in defining one tile track for each slice partitioning of the stream and one tile base track for the NAL units common to the slices. It could be also possible to group more than one slice for example as a sub picture in one tile track. For example, the file 800 contains two slices, one with the identifier ‘1.1’ and another one with identifier ‘1.2’. The samples corresponding to each slice ‘1.1’ and ‘1.2’ are described respectively in one tile track similarly to tile tracks of in ISO/IEC 14496-15. While initially designed for HEVC, the VVC slices could be encapsulated in tile tracks. This VVC tile track could be differentiated from HEVC tile track by defining a new sample entry for instance ‘vvt1’ instead of ‘hvt1’. Similarly, a tile base track for HEVC is extended to support VVC format. This VVC tile base track could be differentiated from HEVC tile base track by defining a different sample entry. The VVC tile base track describes NAL units common to the two slices. Typically, it contains mainly non-VCL NAL unit such as the Parameter Sets and the SEI NAL units. For example, it can be one of the Parameters Sets NAL units

First, the merging method consists in determining in step 900 the set of tile tracks from the two streams to be merged in a single bitstream. For instance, it corresponds to the tile tracks of the slice with the identifier ‘2.1’ of 801 file and of the slice with identifier ‘1.2’ of the file 800.

Then the method in a step 901 determines the new decoding locations of the slices and generates new Parameter Sets NAL units (i.e. SPS or PPS and APS) to describe these new decoding locations in the resulting stream accordingly to the embodiments described above. The method generates also non-VCL NAL units such as SEI that include rewriting information to rewrite the slice headers when Parameter Set collision are observed. Since all the modifications consist in modifying only the non-VCL NAL units, it is equivalent to generating in a step 902 a new Tile Base Track. The samples of the original tile tracks corresponding to the extracted slices remains identical. The ‘tile tracks of the file 802 reference the tile base tracks with a track reference type set to ‘tbas’. The tile base track references as well the tile tracks with a track reference type set to ‘sbat’.

The advantage of this method is that combining two streams consists mainly in generating a new tile base track and update the track reference boxes and copying as is the tile tracks samples corresponding to the selected slices. The processing is simplified since rewriting process of the tile tracks samples is minimized compared to prior art.

According to an embodiment of the invention, the video sequence includes sub pictures. According to this embodiment, the merge operation comprises the insertion of the SEI messages interleaved with the VCL NAL units. The VCL NAL units are not modified, and the slice headers keep their APS identifiers.

At decoding, when decoding a slice, the decoder needs to identify the right APS corresponding to the slice.

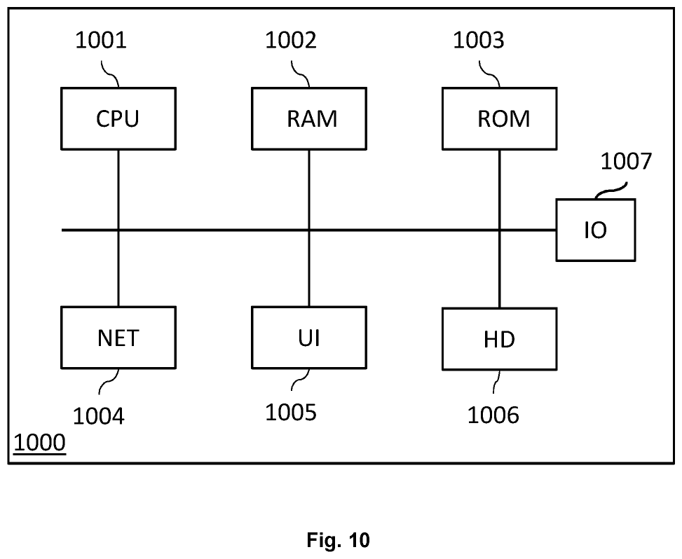

FIG. 10 is a schematic block diagram of a computing device 1000 for implementation of one or more embodiments of the invention. The computing device 1000 may be a device such as a microcomputer, a workstation or a light portable device.

The computing device 1000 comprises a communication bus connected to:
a central processing unit 1001, such as a microprocessor, denoted CPU;
a random access memory 1002, denoted RAM, for storing the executable code of the method of embodiments of the invention as well as the registers adapted to record variables and parameters necessary for implementing the method according to embodiments of the invention, the memory capacity thereof can be expanded by an optional RAM connected to an expansion port, for example;
a read only memory 1003, denoted ROM, for storing computer programs for implementing embodiments of the invention;
a network interface 1004 is typically connected to a communication network over which digital data to be processed are transmitted or received. The network interface 1004 can be a single network interface, or composed of a set of different network interfaces (for instance wired and wireless interfaces, or different kinds of wired or wireless interfaces). Data packets are written to the network interface for transmission or are read from the network interface for reception under the control of the software application running in the CPU 1001;
a user interface 1005 may be used for receiving inputs from a user or to display information to a user;
a hard disk 1006 denoted HD may be provided as a mass storage device;
an I/O module 1007 may be used for receiving/sending data from/to external devices such as a video source or display.

The executable code may be stored either in read only memory 1003, on the hard disk 1006 or on a removable digital medium such as for example a disk. According to a variant, the executable code of the programs can be received by means of a communication network, via the network interface 1004, in order to be stored in one of the storage means of the communication device 1000, such as the hard disk 1006, before being executed.

The central processing unit 1001 is adapted to control and direct the execution of the instructions or portions of software code of the program or programs according to embodiments of the invention, which instructions are stored in one of the aforementioned storage means. After powering on, the CPU 1001 is capable of executing instructions from main RAM memory 1002 relating to a software application after those instructions have been loaded from the program ROM 1003 or the hard disk (HD) 1006, for example. Such a software application, when executed by the CPU 1001, causes the steps of the flowcharts of the invention to be performed.

Any step of the algorithms of the invention may be implemented in software by execution of a set of instructions or program by a programmable computing machine, such as a PC (“Personal Computer”), a DSP (“Digital Signal Processor”) or a microcontroller; or else implemented in hardware by a machine or a dedicated component, such as an FPGA (“Field-Programmable Gate Array”) or an ASIC (“Application-Specific Integrated Circuit”).

Although the present invention has been described herein above with reference to specific embodiments, the present invention is not limited to the specific embodiments, and modifications will be apparent to a skilled person in the art which lie within the scope of the present invention.

Many further modifications and variations will suggest themselves to those versed in the art upon making reference to the foregoing illustrative embodiments, which are given by way of example only and which are not intended to limit the scope of the invention, that being determined solely by the appended claims. In particular the different features from different embodiments may be interchanged, where appropriate.

Each of the embodiments of the invention described above can be implemented solely or as a combination of a plurality of the embodiments. Also, features from different embodiments can be combined where necessary or where the combination of elements or features from individual embodiments in a single embodiment is beneficial.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The information coded in the SEI NAL units could also be encoded in other non-VCL units like a Video Parameter Set VPS, Sequence Parameter Set SPS or the DPS or new units like Layer Parameter Set, or Slice Parameter Set or the APS. These units define parameters valid for several pictures and thus there are at a higher hierarchical level than the slice units in the video bitstream. The slice units are valid only inside one picture. The APS units can be valid for some pictures but their usage changes rapidly from one picture to another.

The Adaptation Parameter Set unit (APS) contains parameters defined for the Adaptive Loop Filter (ALF). In some variants, the APS may contain several loop filters parameter sets with different characteristics. The CTU using a particular APS can then select which particular loop filter parameter set is used. In another variant, the video can also use other types of filters (SAO, deblocking filters, post processing filter, Reshaper or LMCS model based filtering, denoising . . . ). Some parameters for some other filters (in-loop and out of loop filters) could also be encoded and stored in some other Parameter Set NAL units (filter parameter set units) referenced by the slice. The same invention could be applied to these new types of units.

In the claims, the word “comprising” does not exclude other elements or steps, and the indefinite article “a” or “an” does not exclude a plurality. The mere fact that different features are recited in mutually different dependent claims does not indicate that a combination of these features cannot be advantageously used.

1. A method of encoding video data comprising pictures into a bitstream of logical units, pictures being divided into picture portions, picture portions being grouped into picture portion groups, the method comprising:
identifying a picture portion group encoded as a picture portion group header and a picture portion group encoded video data, the picture portion group header comprising at least one identifier of a logical unit containing a parameter set;
generating rewriting information comprising a new value of the identifier of the logical unit containing the parameter set;
encoding the video data into a bitstream comprising the picture portion group and the rewriting information.

2. The method of claim 1, wherein the rewriting information further comprises a picture portion group identifier of the picture portion group.

3. The method of claim 1, wherein rewriting information further comprises an initial value of the identifier of the logical unit containing the parameter set.

4. The method of claim 1, wherein rewriting information comprises a data block of values of a set of identifiers of logical units containing parameter sets, the data block corresponding to at least a part of a similar data block in the picture portion group header.

5. The method of claim 1, wherein:
rewriting information further comprises an identifier of a second parameter set logical unit that contains an information allowing to determine whether the logical unit containing the parameter set is used for the picture portion group; and
a new value of an identifier of a logical unit containing a parameter set is present in the rewriting information only if the logical unit containing the parameter set is used for the picture portion group.

6. The method of claim 1, wherein the method further comprises:
generating a second rewriting information comprising the new value of the identifier of the logical unit containing the parameter set; and
inserting the second rewriting information into the bitstream to indicate that the next logical unit containing the parameter set with the initial value of the identifier in the bitstream has to be rewritten.

7. The method of claim 6, wherein the second rewriting information comprises a set of new values of identifiers of logical units containing parameter sets.

8. The method of claim 6, wherein the second rewriting information and the rewriting information are comprised in a single logical unit.

9. The method of claim 1, wherein the method comprises:
determining a set of picture portions as a set of motion constrained picture portions; and
associating the rewriting information with the set of motion constrained picture portions.

10. The method of claim 1, wherein:
pictures are further divided into sub-pictures, sub-pictures being divided into picture portions; and
rewriting information further comprises a sub-picture identifier.

11. The method of claim 1, wherein the rewriting information is included into a supplemental enhancement information logical unit.

12. The method of claim 11, wherein the supplemental enhancement information logical unit is inserted into the bitstream prior to any logical unit containing encoded video data.

13. The method of claim 1, wherein the rewriting information is included into a dedicated logical unit.

14. The method of claim 1, wherein the rewriting information is included into a parameter set logical unit.

15-17. (canceled)

18. A method for decoding a bitstream of logical units of video data comprising pictures, pictures being divided into picture portions, picture portions being grouped into picture portion groups, the method comprising:
parsing rewriting information comprising a new value of an identifier of a logical unit containing a parameter set;
identifying a picture portion group encoded as a picture portion group header and a picture portion group encoded video data, the picture portion group header comprising at least one identifier of the logical unit containing the parameter set;
rewriting the picture portion group header by replacing the identifier of the logical unit containing the parameter set by the new value comprised in the rewriting information; and
decoding the bitstream with the rewritten picture portion group header.

19-34. (canceled)

35. A method for merging picture portion groups from a plurality of original bitstreams of video data into a resulting bitstream, bitstreams being composed of logical units comprising pictures, pictures being divided into picture portions, picture portions being grouped into picture portion groups, the method comprising:
parsing logical units comprising a picture portion group to determine an identifier of a logical unit containing a parameter set associated with the picture portion group;
determining that the identifier of the logical unit containing the parameter set associated with the picture portion group is conflicting with another identifier of another logical unit containing another parameter set in another picture portion group;
generating rewriting information comprising a new value of the identifier of the logical unit containing the parameter set;
generating the resulting bitstream comprising the logical units comprising the picture portion group, the rewriting information and the encoded logical units comprising the parameter sets.

36-51. (canceled)

52. A method of generating a file comprising a bitstream of logical units of encoded video data comprising pictures, pictures being divided into picture portions, picture portions being grouped into picture portion groups, the method comprising:
encoding the bitstream according to claim 1;
generating a first track comprising the logical units containing the parameter sets, and the rewriting information;
generating for a picture portion group, a track containing the logical unit containing the picture portion group; and,
generating the file comprising the generated tracks.

53-54. (canceled)

55. A non-transitory computer-readable storage medium storing instructions of a computer program for implementing a method according to claim 1.

56. (canceled)
